(19) United States
(12) Patent Application Publication
(10) Pub. No.: US 2014/0331265 A1
(43) Pub. Date: Nov. 6, 2014

(54) INTEGRATED INTERACTIVE TELEVISION ENTERTAINMENT SYSTEM

(71) Applicant: Microsoft Corporation, Redmond, WA (US)

(72) Inventors: William Michael Mozell, North Vancouver (CA); David Seymour, Vancouver (CA); Henry Stuart Denison Watson, Vancouver (CA); Ahmed Usman Khalid, Port Coquitlam (CA); Eric Conrad Bridgwater, Vancouver (CA); Remus Gabriel Radu, Port Moody (CA); Cameron David James McRae, Port Coquitlam (CA); Michael James Perzel, Vancouver (CA); Jackie Yu Hao Li, Richmond (CA); David Thomas Ferguson, Vancouver (CA)

(73) Assignee: Microsoft Corporation, Redmond, WA (US)

(21) Appl. No.: 14/266,554

(22) Filed: Apr. 30, 2014

Related U.S. Application Data
(60) Provisional application No. 61/818,422, filed on May 1, 2013.

(51) Int. Cl. H04N 21/2668

(52) U.S. Cl. CPC H04N 21/2668
USPC 725/93

(57) ABSTRACT

A system and method are disclosed for enhancing a television viewing experience by a group of one or more users. The experience is enhanced by integrating services from a number of different sources. This integration of services aggregates cloud data, identifies content from the aggregated cloud data that is potentially of interest to the user, and distributes that content to a main display or one or more secondary computing devices associated with the one or more users in the group.

### PRIORITY CLAIM

This application claims priority to U.S. Provisional Patent Application No. 61/818,422, filed May 1, 2013, entitled, “System and Methods for Enhanced Television Viewing Experience,” which is incorporated herein by reference in its entirety.

### BACKGROUND

While television viewing has been a popular leisure activity for decades, in the face of newer technologies such as the internet and the availability of media content on personal mobile devices, modern users may find the television experience lacking. For example, current systems do not create an enhanced entertainment viewing experience integrating content from multiple sources. Current system also do not create an enhanced entertainment experience for multiple consumer devices that enables the users to interact with content while watching video.

### SUMMARY

A system and method are disclosed for enhancing a television viewing experience by a group of one or more users. The experience is enhanced by integrating services from a number of different sources. This integration of services aggregates cloud data, identifies content from the aggregated cloud data that is potentially of interest to the user, and distributes that content to a main display or one or more secondary computing devices associated with the one or more users in the group.

In one example, the present technology relates to a method for presenting content via a display screen associated with a computing device, comprising: (a) aggregating, in a central service, cloud data from a plurality of sources remote from the central service; (b) identifying, in the central service, content from cloud data aggregated in said step (a) that is potentially of interest to a user of the computing device; and (c) forwarding the content identified in said step (b) for display on the display associated with the computing device.

In another example, the present technology relates to a system for presenting content via a display screen associated with a computing device, the system comprising: an aggregation service for aggregating cloud data from one or more third-party content providers; a user preference service for receiving user preferences from a user of the computing device; a content determination service for examining the cloud data and user preferences and identifying content to forward to the computing device based on an identified relation between the cloud data and the user preferences; and a programming tool including a set of rules for formatting a user interface for the presentation of the content identified by the content determination service.

In a further example, the present technology relates to a computer-readable medium for programming a processor to perform a method of presenting content via a display screen associated with a computing device, comprising: (a) aggregating cloud data from a plurality of sources remote from the central service; (b) receiving user preferences for a group of one or more users; (c) identifying content from cloud data aggregated in said step (a) that is potentially of interest to a user of the computing device; (d) defining a group of two or more channels, the content identified in said step (c) divided by content subject matter into the two or more channels; (e) setting a layout of a user interface for displaying the group of two or more channels and content identified in said step (c); and (f) forwarding the content identified in said step (c), the channels defined in said step (d) and the layout set in said step (e) for displaying the content on the display associated with the computing device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram of a network topology for implementing aspects of the present technology.

FIG. 2 is a block diagram of components of a central service according to embodiments of the present technology.

FIG. 3 is an illustration of a group of users viewing content on a television display in accordance with aspects of the present technology.

FIG. 4 is a flow diagram illustrating processes performed in an embodiment of the present technology.

FIGS. 5-8 depict graphical user interfaces according to embodiments of the first module.

FIGS. 9-10 are illustrations of a system displaying notifications according to embodiments of the second module.

FIGS. 11-13 depict graphical user interfaces according to embodiments of the third module.

FIGS. 14-15 are illustrations of a system displaying targeted notifications according to embodiments of the fourth module.

FIGS. 16-17 depict graphical user interfaces according to embodiments of the fifth module.

FIG. 18 illustrates a further embodiment including a NUI interface for interacting with a computing device according to the present technology.

FIG. 19 is a block diagram depicting the components of an example entertainment console.

### DETAILED DESCRIPTION

Embodiments of the present technology relate integrating services from a number of sources which together provide an enhanced and interactive television entertainment experience. One embodiment of the present technology includes a central service for providing customized content that may be downloaded and displayed on the computing device(s) of one or more users. The central service may aggregate cloud data from a number of third-party services. The central service may also receive user preferences from the one or more users. By identifying correlations between the aggregated cloud data and the user preferences, the central service may identify content which is potentially of interest to the one or more users. The central service may further define a layout of a user interface for displaying the identified content. This layout may for example include division of the identified content by subject matter between a number of channels. This layout may additionally or alternatively include a number of windows and/or display tiles for displaying the content.

Embodiments of the technology described below are presented in the context of sports-related entertainment, enhanced with electronic notifications relating to additional sports-related web content. However, it is understood that the present technology may be used to present a television experience and/or notifications that are unrelated to sports. Such television experiences and notifications may relate in whole or in part to news and current events, entertainment, shopping, music videos, and other subject matter.

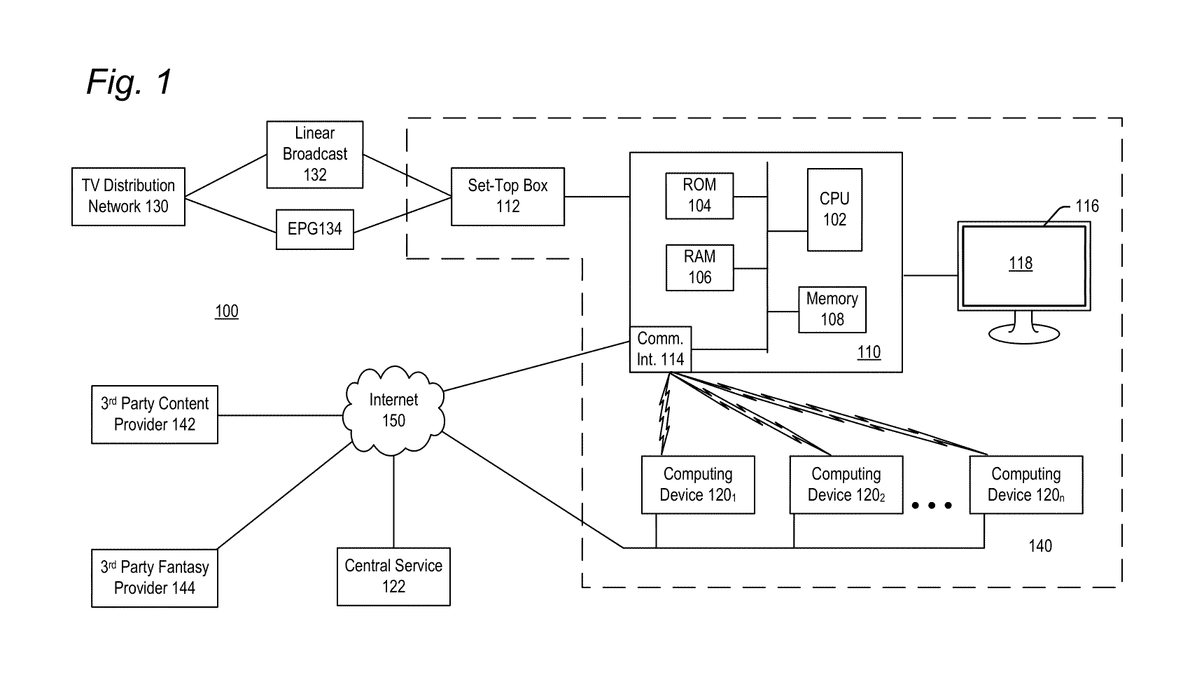

Referring to FIG. 1, there is shown a schematic block diagram of a network topology 100 for implementing embodiments of the present technology. Network topology 100 includes infrastructure for presenting integrated content to a group of one or more users. The content may come from any of a variety of sources and may relate to a variety of different subject matter. In examples, the content may be a traditional linear television broadcast. Such linear broadcasts may be provided by a television distribution network 130, which may be for example a terrestrial television network (ABC, CBS, NBC, etc.), a cable TV provider, a satellite TV provider or other television distribution network.

The network 130 distributes a video feed including a linear broadcast 132 and an electronic program guide (EPG) 134. The linear broadcast feed may be any traditional broadcast television content. As explained below, the linear broadcast (or other IPTV or web content) may be displayed on a main display, with additional customized content displayed around the linear broadcast, or over the linear broadcast. The linear broadcast (or other IPTV or web content) may also be referred to herein as an underlying video.

The EPG includes a breakdown of programming information by channel as to what linear broadcast content is presented and the times of such broadcasts. The EPG data may be customized by geographic location, and further typically includes metadata related to the linear broadcast, including for example a title of the linear broadcasts, the type of video broadcast (sports, entertainment, news, etc.), who is to appear in the linear broadcasts, and a numeric identifier for each linear broadcast.

The linear broadcast 132 and EPG 134 may be received within a set-top box 112 for presentation on a display 118 of a television or other A/V device 116. Display 118 is also referred to herein as the main display, as it may be viewed by the group as a whole. The set-top box 112 and A/V device 116 may be collocated within a location 140 (indicated by the dashed line in FIG. 1) such as for example a home, office, sports bar, etc. A computing device 110 (also referred to herein as primary computing device 110) may also be present at location 140, connected between the set-top box 112 and the A/V device 116. The linear broadcast 132 and EPG from the set-top box 112 may be transmitted through the computing device 110 to the A/V device 116. In embodiments, HDMI connections may be used between the set-top box 112 and the computing device 110 so that the linear broadcast 132 may be rendered as an HDMI pass-through video by the computing device 110 on the A/V device 116.

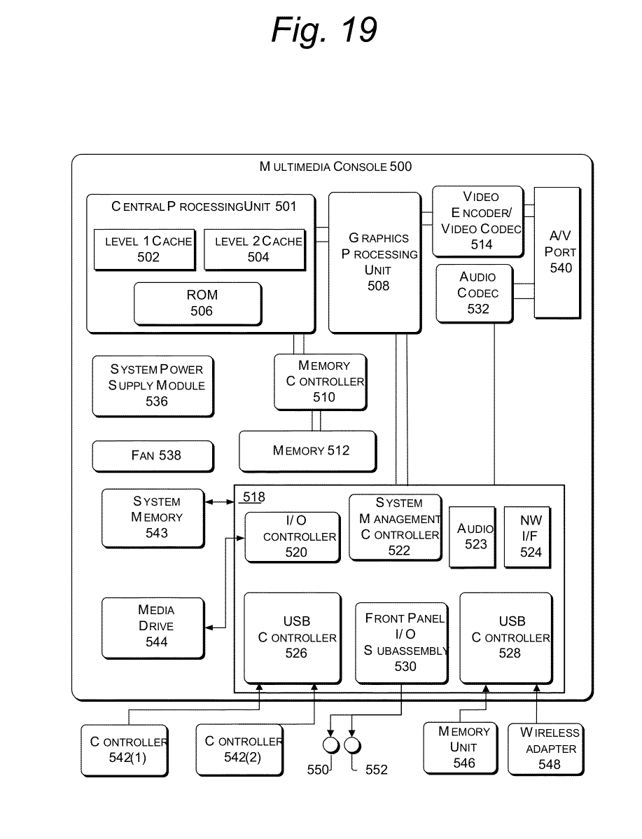

Details of an implementation of computing device 110 are provided below with respect to FIG. 19. However, in general, computing device 110 may be a desktop computer, media center PC, a gaming console and the like. As one example allowing HDMI pass-through, computing device 110 may be the Xbox One® video game console from Microsoft Corp., Redmond, Calif. Computing device 110 may alternatively be a portable computer such as a laptop, tablet or other device in further embodiments. Computing device 110 may include a processor such as CPU 102 having access to read only memory (ROM) 104 and random access memory (RAM) 106. Device 110 may further include a non-volatile memory 108 for storing data and application programs, such as for example application programs for enhancing the television viewing and entertainment experience as explained below.

The computing device 110 may be connected to the A/V device 116, which may for example be a monitor, a high-definition television (HDTV), or the like that may provide a video feed, game or application visuals and/or audio. For example, the computing device 110 may include a video adapter such as a graphics card and/or an audio adapter such as a sound card that may provide audio/visual signals associated with recorded or downloaded linear broadcasts and web content. In one embodiment, the audio/visual device 116 may be connected to the computing device 110 via, for example, an S-Video cable, a coaxial cable, an HDMI cable, a DVI cable, a VGA cable, a component video cable, or the like. In further embodiments, the display 118 may not be a separate A/V device 116, but may instead be incorporated as part of computing device 110.

In an example mentioned above, the content displayed on the main display 118 to the group may be linear video content from a television distribution network 130. This content may be played back in real time (i.e., at the time it is transmitted from the television distribution network), or stored on primary computing device 110 or an associated DVR (not shown) for later playback. In further examples, the content displayed on the main display 118 may be IPTV web videos and/or other content from the central service 122 or directly from a third-party content provider 142.

In further embodiments, the content displayed on the main display 118 may be a video game executing on the primary computing device 110 and/or central service 122 (via a browser running on the primary computing device 110). The content being viewed on the main display 118 may further be still images, graphics and/or photographs, such as for example in a slide show. In still further embodiments, the content displayed on the main display 118 may be remote participants in a video web conference.

The topology 100 may further include a plurality secondary computing devices 120₁, 120₂, . . . , 120ₙ (collectively or individually referred to herein as secondary computing devices 120) at the location 140. Each user in the group may have an associated secondary computing device 120 for receiving electronic notifications and, possibly, for interacting with or supplementing the content displayed on the main display 118. The secondary computing devices 120 may be portable computers such as laptops, tablets, smartphones or other hand-held digital assistants. One or more of the secondary computing devices 120 may be desktop computers in further embodiments. Details of an implementation of a secondary computing device 120 are described below with respect to FIG. 19. However, in general, secondary computing devices 120 may include a processor such as CPU 102 having access ROM 104, RAM 106 and a non-volatile memory 108 for storing data and application programs (as shown in the primary computing device 110).

In embodiments, the primary computing device 110 and secondary computing devices 120 may communicate with each other via a distributed computing environment. In such embodiments, devices 110 and 120 may be linked through a communications network implemented for example by communications interfaces 114 in the computing devices 110 and 120. One such distributed computing environment may be accomplished using the Smartglass™ software application from Microsoft Corporation which allows a first computing device to act as a display, controller and/or other peripheral to a second computing device.

It is also contemplated that one or more secondary computing device 120 may not have a direct network connection to the primary computing device 110. In that situation, the secondary computing device(s) may communicate with the primary computing device 110 via the Internet 150. In embodiments, users in the group and their secondary computing devices 120 are collocated with the primary computing device 110 at location 140 so that the users can view the main display 118. However, in an alternative embodiment, it is possible that one or more users in the group are remote from the location 140. Such a remote user would not be able to view the main display 118, but may still be able to receive electronic notifications intended for the group as a whole and for specific members including the remote user.

It is understood that the functions of computing devices 110 and/or 120 may be performed by numerous other general purpose or special purpose computing system environments or configurations. Examples of other well-known computing systems, environments, and/or configurations that may be suitable for use with the system include, but are not limited to, multiprocessor systems, microprocessor-based systems, set-top boxes, programmable consumer electronics, network PCs, minicomputers, distributed computing environments that include any of the above systems or devices, and the like.

The networked topology 100 may further include a central service 122 and third-party services 142, 144 for providing content and a variety of services to the primary computing device 110 and/or secondary computing devices 120. The third-party content provider 142 may be a website, platform, content provider and/or service which monitors, collects and/or provides content relating to any of various subject matter. For example, the third-party content provider 142 may be sports-related content provider which monitors current events in sports, sports teams, game results etc. As explained below, this content may be provided to the central service 122. The third-party content provider 142 may be owned, associated with or partnered with the central service 122. In further embodiments, the third-party content provider 142 may be independent of the central service 122. FIG. 1 illustrates a single third-party content provider 142, but there may be more than one such provider 142 in further embodiments.

The third-party fantasy provider 144 may be a website, platform, content provider and/or service which hosts, monitors, collects and/or provides content relating to sports fantasy leagues. For example, the third-party fantasy provider 144 may collect and distribute fantasy related information including for example sports fantasy team rosters for different users, fantasy team matchup schedules, player statistics, player recommendations, fantasy league rules and fantasy point calculation, etc. for fantasy sports leagues. The third-party fantasy provider 144 may be owned, associated with or partnered with the central service 122. In further embodiments, the third-party content provider 142 may be independent of the central service 122. FIG. 1 illustrates a single third-party fantasy provider 144, but there may be more than one such provider 144 in further embodiments.

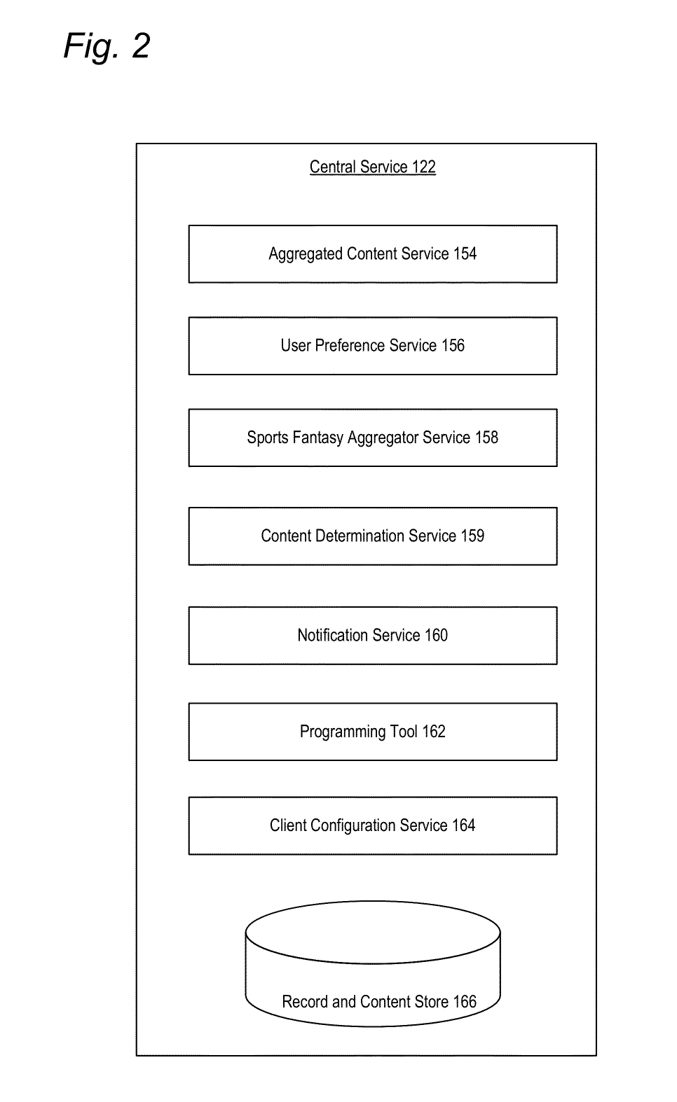

Further details relating to an embodiment of the central service 122 will now be described with reference to the block diagram of FIG. 2. Central service 122 is described below as including a variety of services which may be implemented, controlled and/or authorized by the central service 122. In further embodiments, it is understood that any of the services described below as being part of central service 122 may instead be implemented independently of the central service 122, for example by an independent website or service provider.

Central service 122 includes one or more servers implementing an aggregated content service 154. Aggregated content service 154 receives and aggregates a variety of content from third-party content provider(s) 142, and organizes it in a manner so that it may be easily consumed by users. The aggregated content may include data, metadata, events and/or one or more data feeds (collectively referred to herein as cloud data or content). The aggregated content service 154 may employ application programming interfaces (APIs) customized for respective third-party content providers 142 to allow the aggregated content service 154 to consume and use the data from the one or more third-party content providers 142. Aggregated content may be stored on a record and content store 166, described below.

The cloud data aggregated by the aggregated content service 154 may include any of a variety of content which could potentially be of interest to users. In the context of sports, the aggregated content may relate to games, matches, schedules, video feed data, scores, statistics, etc. from third-party content provider(s) 142. The record and content store 166 and the aggregated content service 154 allow users to customize their access and viewing of the aggregated data. This customized access of the aggregated data allows portions of the aggregated data to be downloaded and viewed in customized ways by different users.

In embodiments, the central service 122 may further include one or more servers implementing a user preference service 156. The user preference service 156 facilitates the collection of user preferences and storage of user preferences on the record and content store 166. In the context of one embodiment of the present technology, user preference service 156 may gather and store sports preference information from a number of users, such as for example their favorite sports, channels, teams and players, sporting events they would like to watch and sports content they would like to receive, etc. This information may additionally or alternatively include a wide variety of other non-sports related information. A user may store this information via the user preference service 156 over time.

The central service 122 may further include one or more servers implementing a sports fantasy aggregator service 158. The sports fantasy aggregator service 158 receives and aggregates a variety of sports fantasy league cloud data from one or more third-party content providers 144 that specifically provide fantasy league-related cloud data. The sports fantasy aggregator service 158 receives and organizes the fantasy cloud data in a manner so that it may be easily consumed by users. The aggregated content service 154 may employ APIs customized for respective third-party fantasy providers 144 to allow the sports fantasy aggregator service 158 to consume and use the cloud data from the one or more third-party fantasy providers 144. The fantasy league cloud data aggregated by the sports fantasy aggregator service 158 may include sports fantasy team rosters, fantasy team matchup schedules, player statistics, player recommendations, etc. for fantasy sports leagues that users participate in. This information may be stored in the record and content store 166.

The central service 122 may further include one or more servers implementing a content determination service 159. As noted above, the aggregated content service 154 and sports fantasy aggregator service 158 collect and store cloud data from third-party providers 142, 144. The user preference service 156 also collects user preferences for one or more users in a group.

It is the role of the content determination service 159 to analyze user preferences and the cloud data to identify content that may potentially be of interest to one or more users in the group. In particular, the cloud data may have associated metadata describing the cloud data. By identifying a correlation between cloud data/metadata and a user preference, the content determination service 159 may infer that the user may be interested in receiving the correlated content.

In this way, the content determination service 159, and central service 122 in general, are able to automatically push content to users that is potentially interesting to the users, without the users having to manually seek out this content. As explained below, the identified content may be formatted on a user interface for consumption by users in a number of different ways. The content may be divided into channels by subject matter. The content may be displayed in thumbnails, or tiles, which may be selected and enlarged to receive the content. The content may be provided on an activity panel, also referred to herein as a chrome, alongside an underlying video. The content may be formatted on a user interface in a number of other ways in further embodiments.

Central service 122 may further include one or more servers implementing a notification service 160. As noted above, the content determination service 159 analyzes aggregated cloud data and user preferences to identify content which may be of interest to a user. In certain instances, this information may relate to a current or upcoming event. In these instances, the present technology may initially send a pop-up notification to see if a user is interested in viewing the identified content. In this instance, where content is determined to be relevant to a user, the notification service 160 generates a notification which is sent to the user via network 150.

This notification may be displayed on the main display 118. The alert notification may be displayed over (on top of) the linear broadcast 132, and may include text and/or graphics generated by the notification service 160 briefly describing the relevant content identified by the notification service 160 as being potentially of interest to the user. Instead of being displayed on the main display 118, the notification service 160 may send an alert to one or more specific users via their respective secondary computing devices 120. In embodiments, the notification service 160 may be consolidated together with the content determination service 159, with notifications being a specific implementation of the content determination service 159.

The central service 122 may further include one or more servers implementing a programming tool 162. It is the role of the programming tool 162 to set how the content is to be displayed on a user interface and how users may interact with that displayed content. In particular, the central service may have administrators that develop application logic, or this application logic may be received from third-party application logic services. This application logic contains a set of rules for determining how content is to appear and behave within a user interface on the main display or displays associated with the secondary devices 120.

The programming tool 162 sets the appearance and behavior of a user interface for displaying content to users by selecting one or more software templates from a library of software templates. The templates that are used may be set by the rules and application logic received from the central service 122 and/or third-party application logic services.

As one example, the programming tool 162 may determine that the content is to be divided into channels. These channels may represent different genres or categories of content. A list of these channels may be displayed to users on the main display 118, and the users may select a channel to thereby display the content defined as being part of that channel. Channels may be defined for any of a wide variety of web content, and channels may include customized content such as highlight reels, event-specific content, current events, etc. Content may be divided into different channels via the cloud data and/or metadata associated with the aggregated content.

The programming tool 162 may additionally or alternatively determine that content is to be displayed on the user interface in windows and tiles, and the programming tool may determine the number and relative sizes of various windows and tiles. The programming tool 162 may further determine the type of data to be presented within the various windows and tiles (video, graphics, text, etc.), and whether or not the windows and/or tiles are interactive.

In embodiments, the central service 122 may further include one or more servers implementing a client configuration service 164. The client configuration service is used to apply customized features as to how the user interface determined by the programming tool 162 is to appear on individual client computing devices. For example, the client configuration service 164 may allow control over the version of application files to download (UI and business logic) as well as control over endpoints referenced by the application at runtime. It can also be used to enable or disable specific features globally or across a subset of users. For example, a user interface presenting content may be customized for different geographic regions, in accordance with application logic generated by administrators of the central service 122 or received from a third-party application logic service. The client configuration service 164 may store a set of rules for altering a default appearance of a user interface, based in these received user preferences and/or regional application logic.

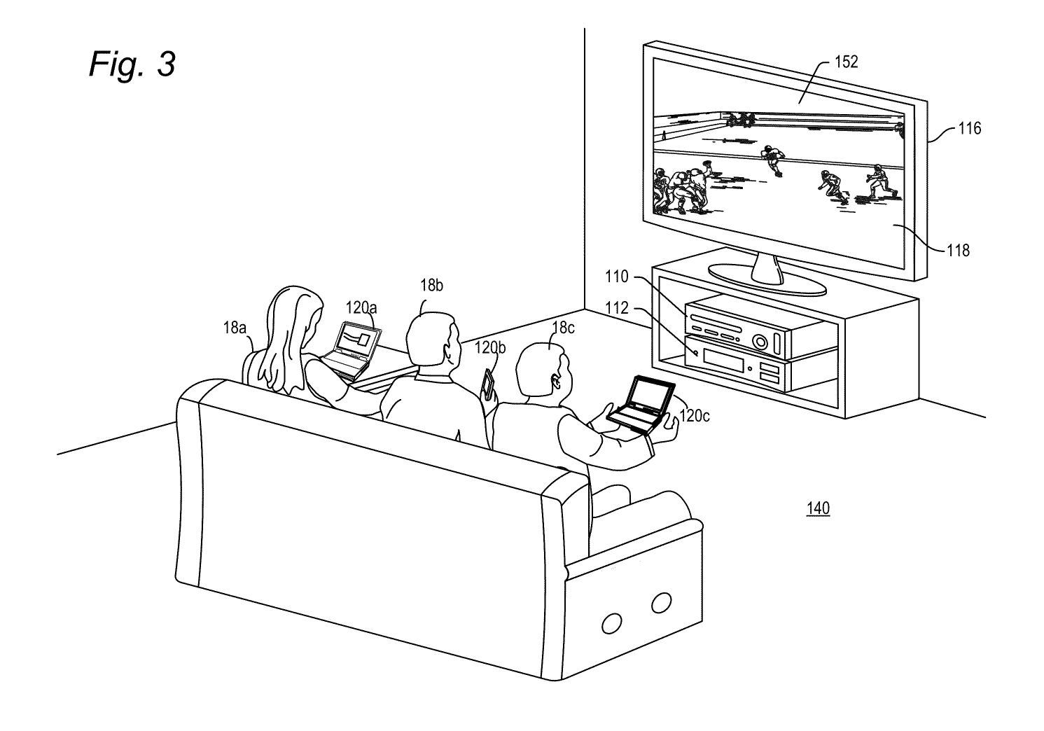

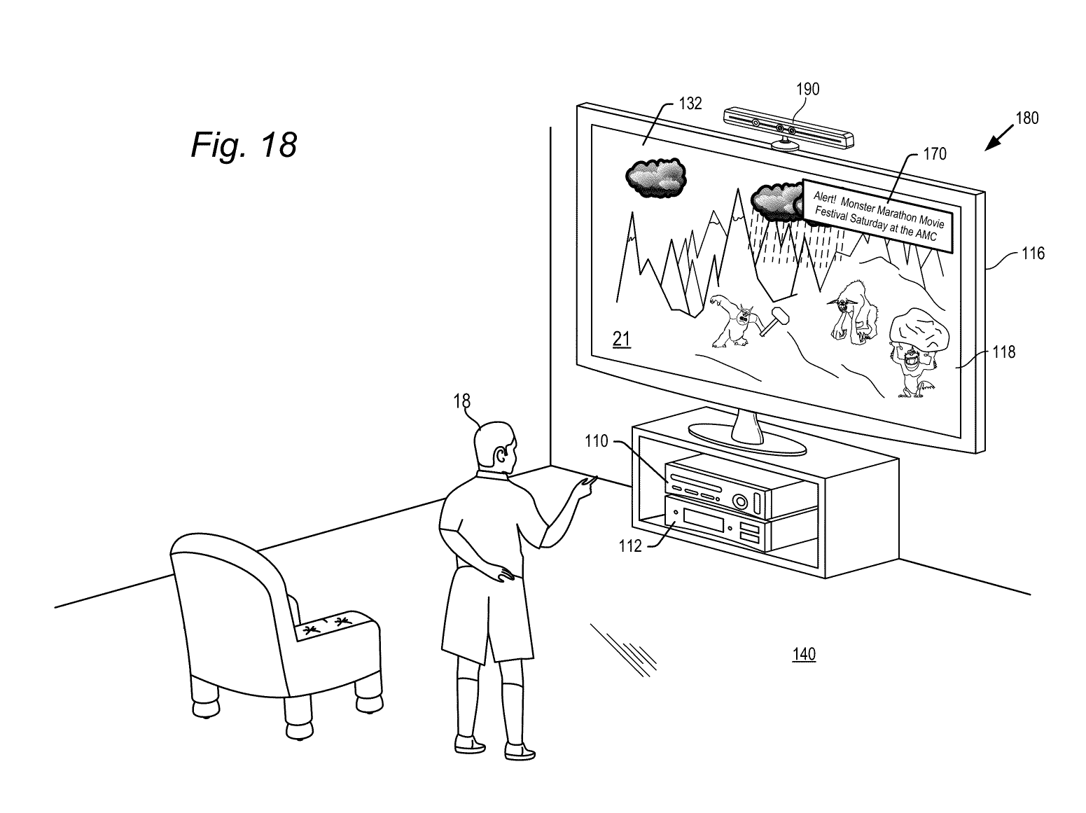

The above-described components and services cooperate and interact to provide an integrated television entertainment experience for a group of one or more users. FIG. 3 illustrates a location 140 with a group of users 18a, 18b, 18c (collectively, users 18) watching content 152 on the main display 118 of an A/V device 116. The example of FIG. 2 illustrates three users in the group, but it is understood that the group may consist of more or less than three users, such as for example up to sixteen or more users in further embodiments. The users 18 may each have a secondary computing device 120 as explained above. The secondary computing devices 120 may be used to interact with and/or control the primary computing device 110. In a further embodiment described below with respect to FIG. 18, the computing device 110 may implement a natural user interface (NUI) system allowing the users to interact with the computing device 110 through gestures and speech.

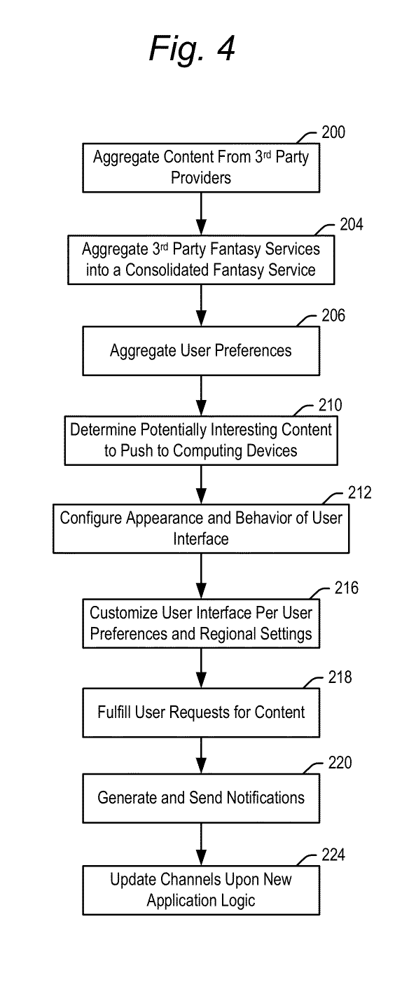

FIG. 4 is a flowchart illustrating the various processes performed by the central service 122 in combination with the other services and television content described above with respect to FIGS. 1-3. While the steps in a flowchart of FIG. 4 a set forth in a particular order, it is understood that these steps may be performed in a variety of differing orders, and that two more steps may be performed simultaneously. Moreover, one or more of the steps in the flowchart of FIG. 4 may be omitted in further embodiments.

In step 200, central service 122 aggregates cloud data from third-party content providers 142. This aggregated content is organized by the aggregated content service 154, and then made available to different services and applications which use this content.

In step 204, the sports fantasy aggregated service 158 may aggregate third-party fantasy cloud data and services into a consolidated fantasy service. In particular, the central service 122 stores information of the different fantasy leagues that subscribing users are part of (from user preferences supplied by users and information obtained from third-party fantasy services). The sports fantasy aggregated service 158 obtains fantasy data relevant to subscribing users from third-party fantasy services 144, and formats and organizes that data in a way that it may be consumed by users. As a few examples, this fantasy data may be divided up into one or more channels, or presented in pop-up notifications as explained below.

In step 206 the user preference service 156 aggregates user preferences for storage on the record and content store 166. These user preferences may be used for a variety of purposes, including for example defining channels and tiles to be shown the particular users, defining the content selected for those channels and tiles, generating notifications, customizing the operation of client applications and/or customizing the appearance of user interfaces generated by client applications.

In step 210, the content determination service 159 determines potentially interesting content to push to a specific user or group of users. As noted above, this may be done by comparing the aggregated cloud data against user preferences to find correlations. In a further embodiment, instead of or in addition to using user preferences to identify relevant content to send, the content determination service 159 may identify the underlying video being shown on the main display and perform a search of the aggregated cloud data (stored on the record and content store 166 or stored at third-party content services) to identify content related to the underlying video. Further details of this feature are explained below.

In step 212, employing the application logic rules and a set of software templates, the programming tool 162 may configure the appearance and behavior of one or more user interfaces on which relevant content is to be displayed to a user or group of users. As noted, this may include defining a list of channels, and a division of a user interface into a number of windows and tiles having relative sizes set by the programming tool 162. In step 216, the client configuration service 164 may customize the appearance and/or behavior of user interface(s) for a particular user or group of users. As noted, in one example, the client configuration service 164 may use region-specific and/or user-specific information in configuring the customized user interface(s).

Users may request content from the central service 122. The central service 122 fulfills requests for on-demand content in step 218. The requested content may be any type of content. The user may request content from the central service, at which point the central service either provides the content from its data store, or goes to a third party provider to get the content.

In step 220, the notification service 160 generates and sends notifications to the main display 118 and/or one or more of the displays of the secondary computing devices 120. In particular, when content relating to a current or upcoming event is identified as being potentially relevant to a user or underlying video by the content determination service 159, the notification service 160 may generate a notification to see if a user or group of users are interested in viewing this content. The notification may relate to any of a wide variety of content, including for example an upcoming sporting event, a current or news-worthy event, a fantasy league event involving one or more users of the group, etc.

Upon identifying current or upcoming content that is relevant to the group as a whole (or at least some predefined portion of the group), the notification service 160 generates a message that is sent to the computing device 110 for display on the main display. The message may be displayed as a pop-up over the underlying video then playing. The notification service may alternatively determine that the content is relevant to some smaller subgroup of one or more users, but not to the group as a whole. In that instance, the notification service 160 may instead send the notification directly to the secondary computing device(s) 120 of the identified user(s). The notification may contain a deep link so that users may action on the notification, at which point additional content relating to the notification is accessed (either through the central service or directly from a third-party provider) and displayed.

In step 224, the central service 122 can dynamically create new channels or update existing channels when application logic running on a server in the central service 122 or a third-party provider is created or updated. As one of many possibilities, a special event, such as for example the Superbowl, may be upcoming. In this event, a new channel dedicated to the Superbowl may be created with application logic at the central service. Thereafter, the new channel may appear in a user interface on the main display 118 including content aggregated by the aggregated content service 154 or directly from a third-party content provider 142. In the same manner, existing channels may be retasked or removed. An administrator of the central service 122 can also set time based rules for when channels should appear/disappear. The administrator can further set default preferences per region allowing more focus on regional content.

The present technology integrates the above-described services and processes together to provide a comprehensive, interactive television experience for users. Following are some examples of features, referred to herein as modules, that the integrated services and processes are able to provide in accordance with embodiments of the present technology.

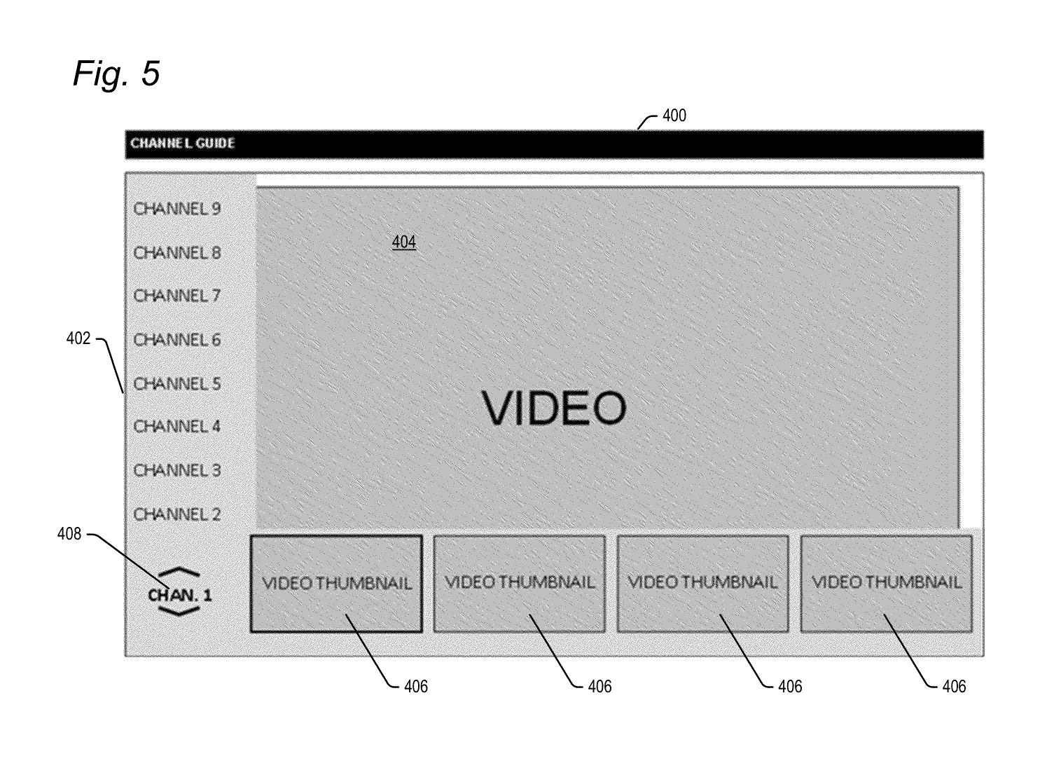

A first module allows users to generate an efficient and customized user interface (“UI”) channel guide. In embodiments, the UI channel guide may be brought up by a user while watching video. The UI channel guide serves as a channel listing categorized by channels which, as indicated above, may be genres or categories of content. FIG. 5 illustrates a user interface 400 including a UI channel guide 402, video content 404 and alternative video content thumbnails (also referred to herein as tiles) 406. As shown, the UI channel guide 402 is provided alongside the video content 404 so that a user may enjoy the content 404 while the same time navigating the channel guide 402. The video content thumbnails 406 may include additional content for the selected channel. Any one of the video content thumbnails 406 may be selected, at which time that video is displayed as a larger video content 404.

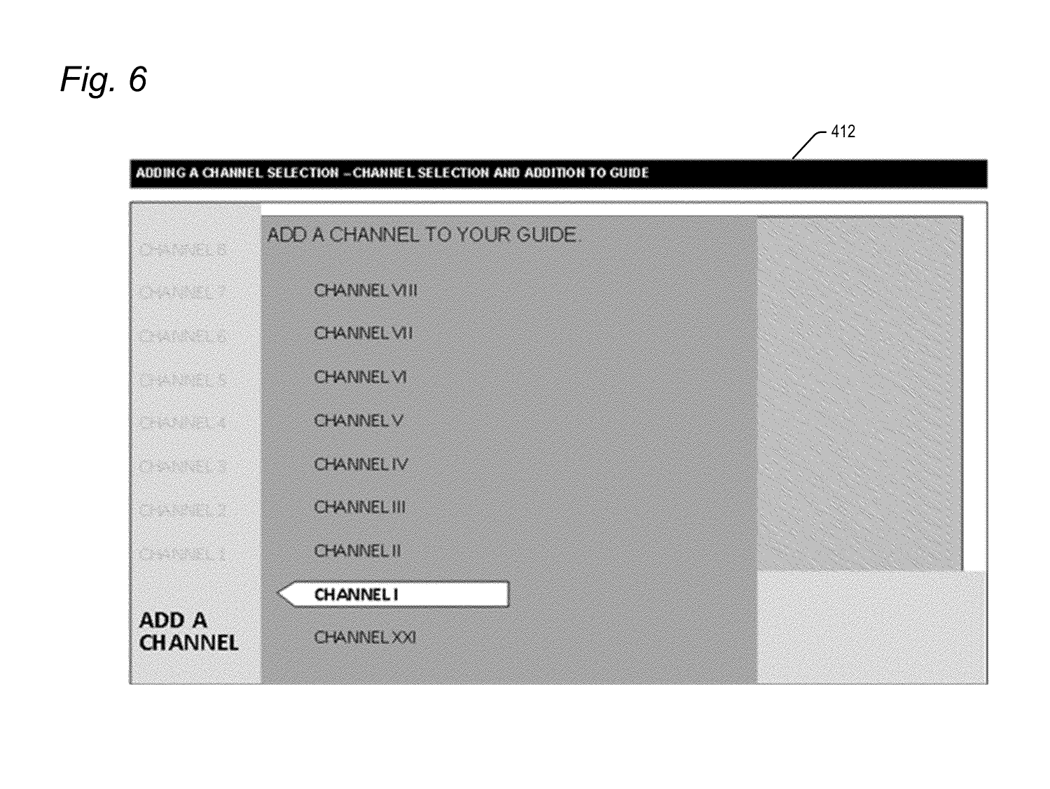

The UI channel guide 402 illustrates 9 channels, but there may be greater or fewer channels in further embodiments. When not all channels may be displayed at the same time, a scrollbar 408 and provided for scrolling between the channels. A default number and genre of channels may be provided by the central service 122 in UI channel guide 402. However, a user may also customize the number and genre of channels in the UI channel guide 402 to add to or replace channels in the UI channel guide 402. For example, FIGS. 6-8 illustrate user interfaces allowing a user to add and customize a new channel to the UI channel guide 402 shown in FIG. 5. In FIG. 6, a user may select a new channel to be added to the UI channel guide 402 from a user interface 412.

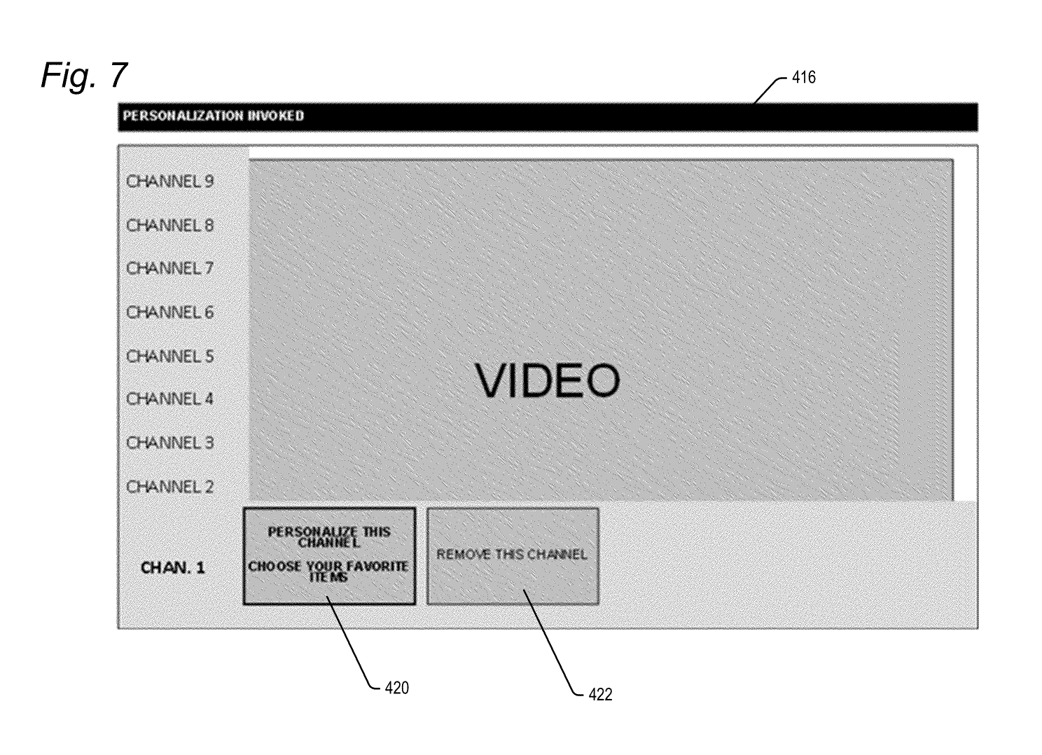

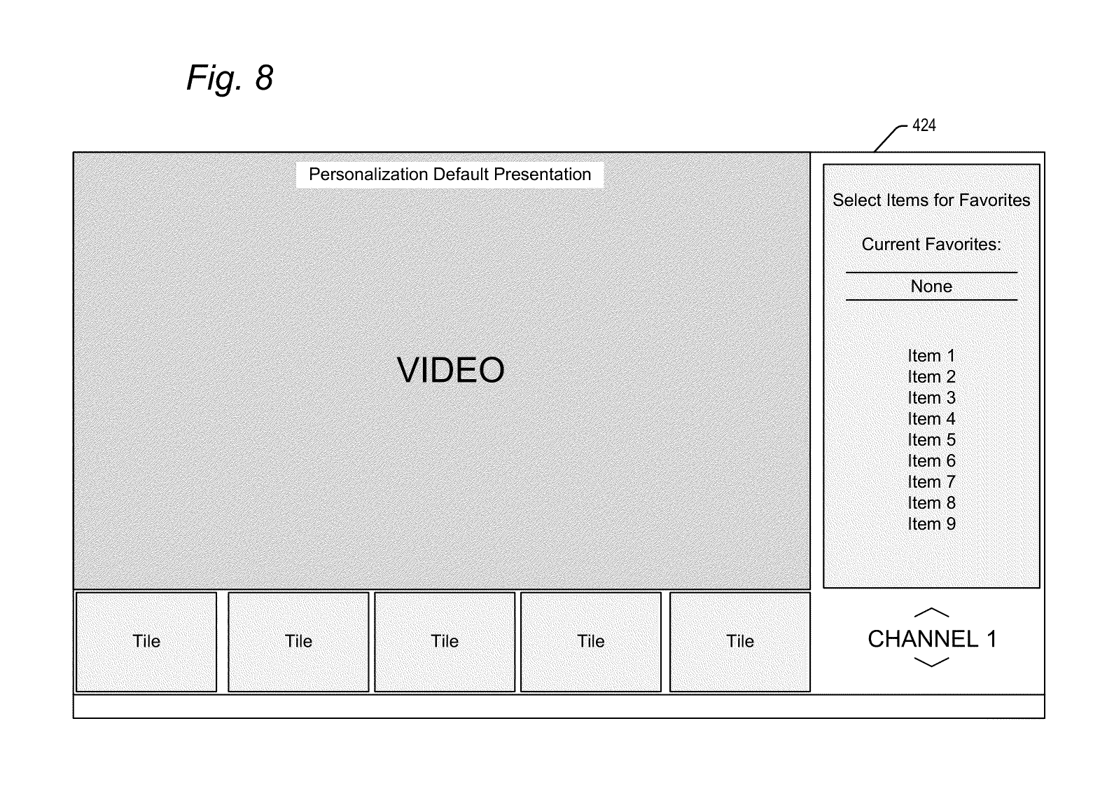

A user may also access a user interface 416 shown in FIG. 7 allowing the user to customize an existing channel upon selection of a content customization button 420. A user is also provided with the option to remove a given channel via a channel removal button 422. Where user selects content customization button 420 with respect to a given channel, a user may presented with graphical user interface 424 shown in FIG. 8. User interface 424 may include a number of items which may be subcategories of the given channel. The subcategories can be any of various subcategories including for example teams for a sports channel, shows for a sitcom channel, and TV personalities for an entertainment channel. These subcategories are provided by way of example only and any of a wide variety of subcategories may be provided as items on user interface 424. A user may choose one or more items from user interface 424 which items will then be used to determine the content provided on the given channel.

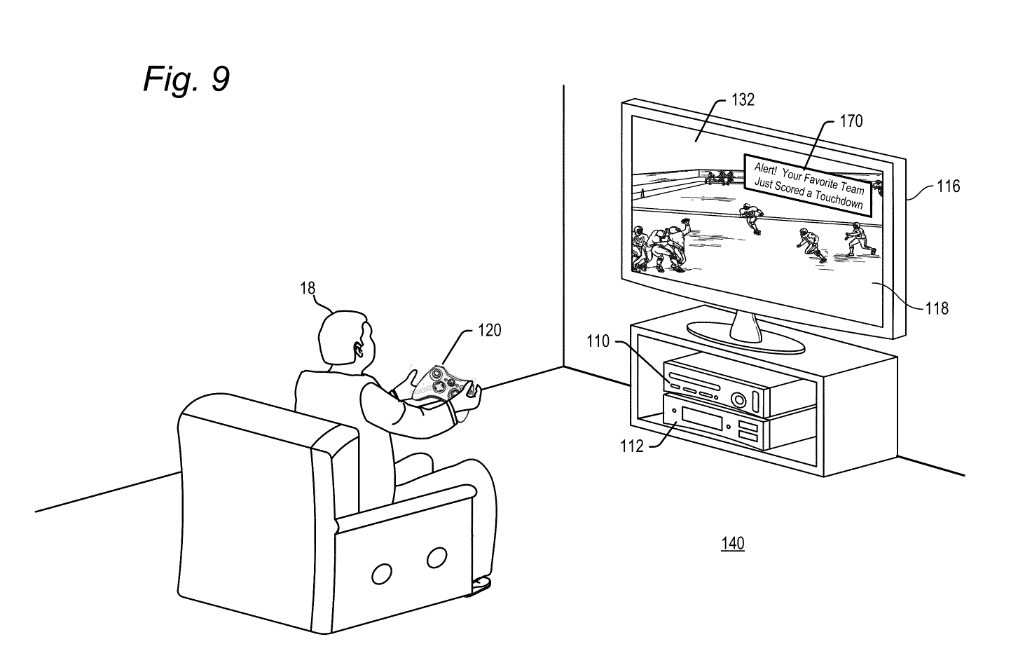

A second module is disclosed for displaying a video and a pop-up notification displayed on top of the video. As noted above, where content is determined to be relevant to a group of one or more users, the notification service 160 of the central service 122 generates an alert which is sent to the user via network 150 and displayed for example on the main display 118. One example of an alert notification 170 is shown in FIG. 9. The alert notification 170 is displayed over (on top of) the linear broadcast 132 (or other content), and includes text and/or graphics generated by the notification service 160 briefly describing the relevant content identified by the central service 122 as being potentially of interest to the user.

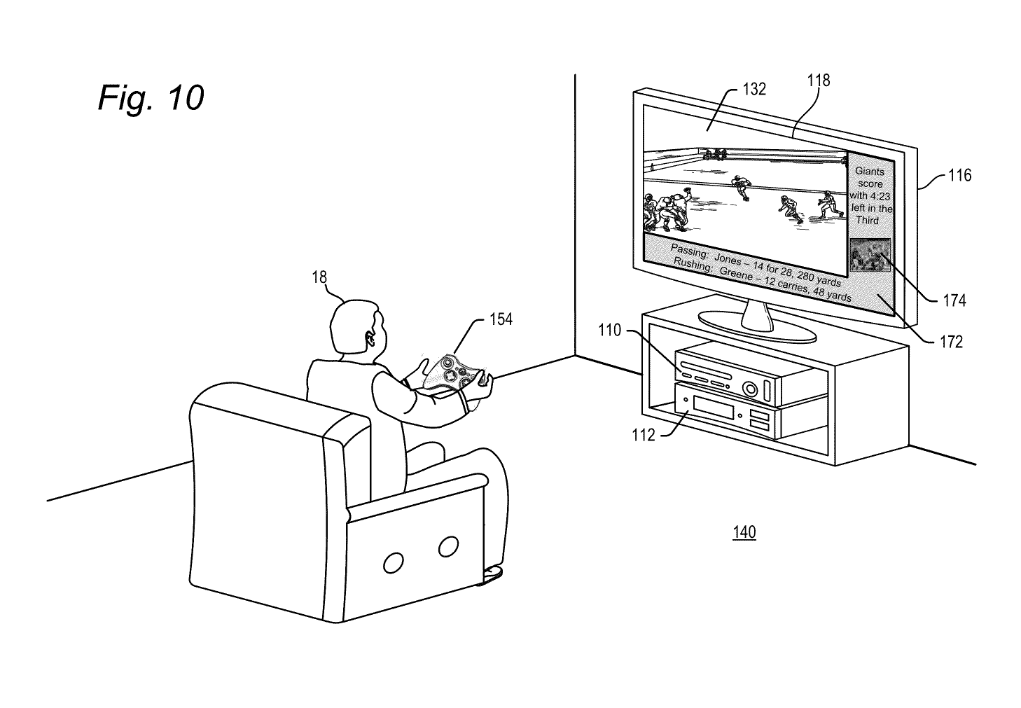

An alert notification 170 may include a deep link such that it may be selected, or actioned on, by a user to trigger presentation of additional information to the user relating to the subject matter of the alert notification 160. If a user actions on an alert notification 170, a user interface chrome 172 may be displayed to a user as shown in FIG. 10. The size of the linear broadcast 132 may also be decreased to accommodate the chrome 172 while still showing all of the linear broadcast 132.

The user interface chrome 172 may include a wide variety of text, graphics and images providing additional information related to the alert notification 170 that was actioned on. For example, for alerts related to a sporting competition, the chrome 172 may display a game summary, a description of one or more events from the competition, related news stories, and/or historical, statistical and biographical information. This information may come from the central service 122, which may generate and store the information on its own, or receive the information from one or more third-party content providers such as providers 142, 144.

The chrome 172 may further include embedded links to additional information located on remote servers (within central service 122 or other third-party providers 142, 144). The user interface chrome 172 may for example include a tile 174 having video link which, when actioned upon, displays an IPTV web video associated with the video link on the A/V device 116.

A third module is disclosed for displaying a linear broadcast 132 or web content in a first window and an activity panel displayed next to or over the first window. The activity panel includes data relating to the broadcast or content displayed in the first window. The activity panel may be interactive so that a user can select a link in the activity panel to explore the linked data in greater detail.

As noted above, in embodiments, a linear broadcast 132 may be rendered as full-screen HDMI pass-through video by computing device 110 onto display 118. In embodiments, the broadcast may be identified, and thereafter a search may be performed to identify information relating to the broadcast. This identification and search may be performed by computing device 110 or central service 122.

In embodiments, the video may for example be identified using data in the EPG 134 for the broadcast and metadata included in the EPG 134 for that broadcast. Alternatively, the central service may keep track of the content being displayed which is able to identify and provide information relating to the video. The client computing device or central service may use the TV program ID from the EPG to query for data or data feeds relevant to the identified TV program video. This query may be performed in one or more servers of the central service 122 or over the World Wide Web in general. The program ID and/or keywords from the metadata associated with the program in the EPG or from the central service may be used as keyword searches to identify relevant data, events and/or data feeds.

It is understood that this information may come from a variety of other sources and may be accumulated in a variety of other manners in further embodiments. The information may be contextual live data information synced with video stream. For example, utilizing score data and stats data feeds delivered through the central service, the live information for the event may be synced with the video feed and delivered to the user as a unified experience.

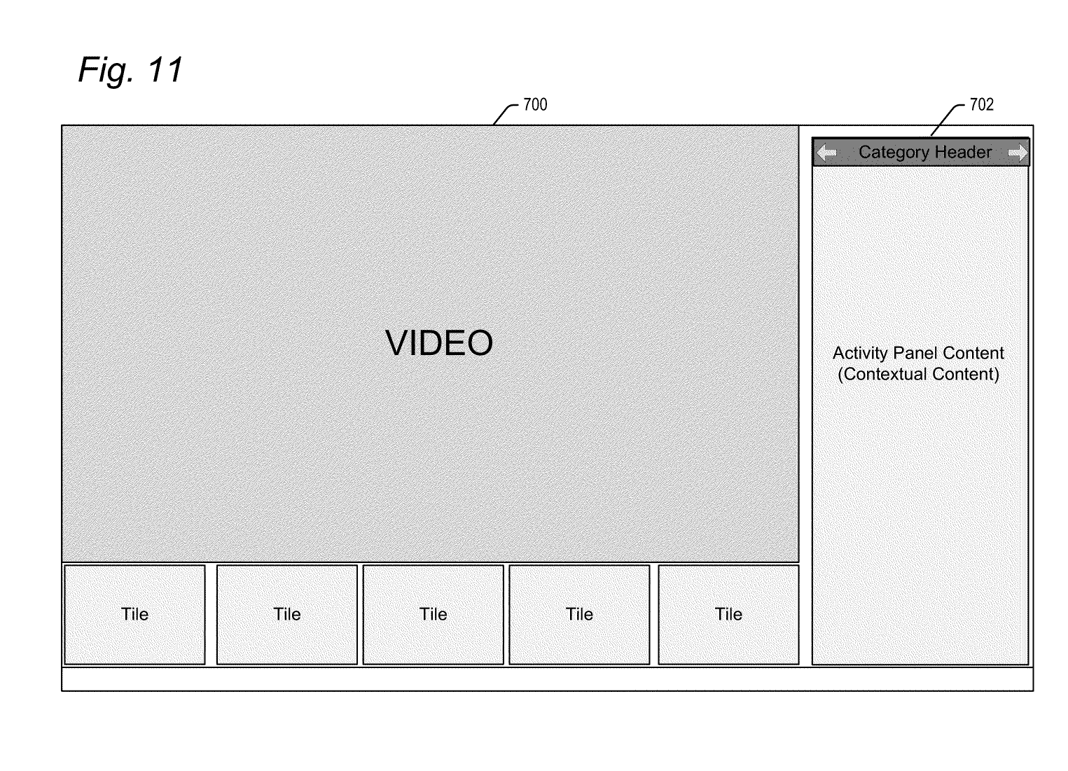

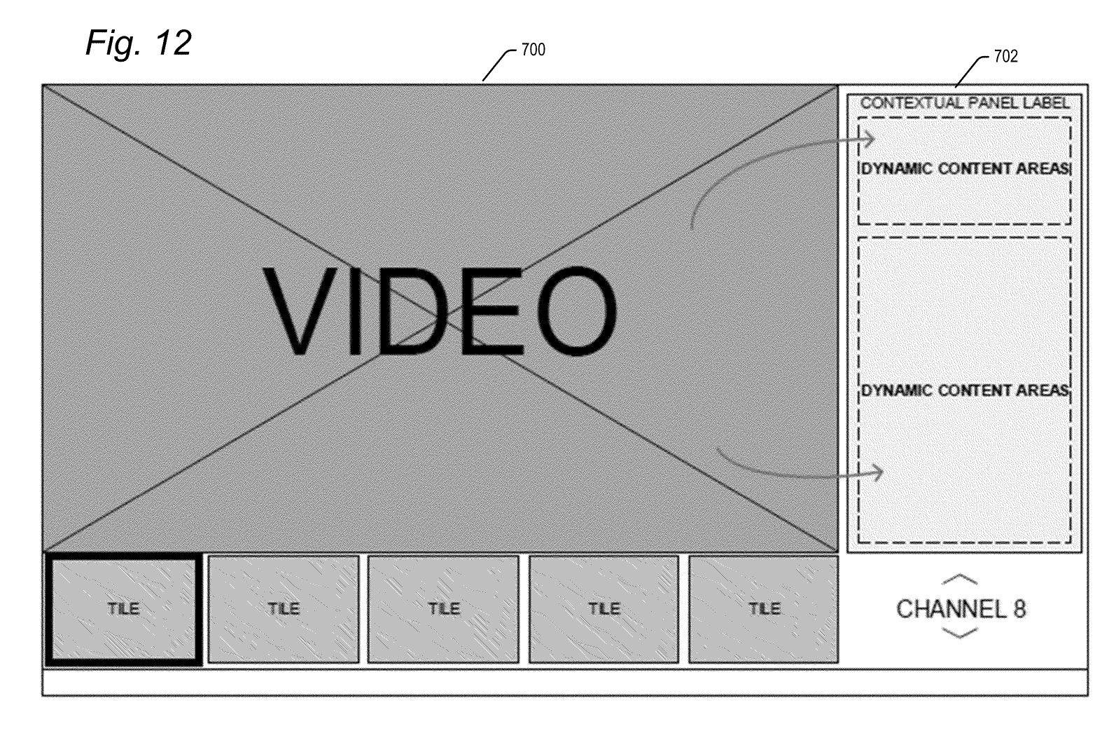

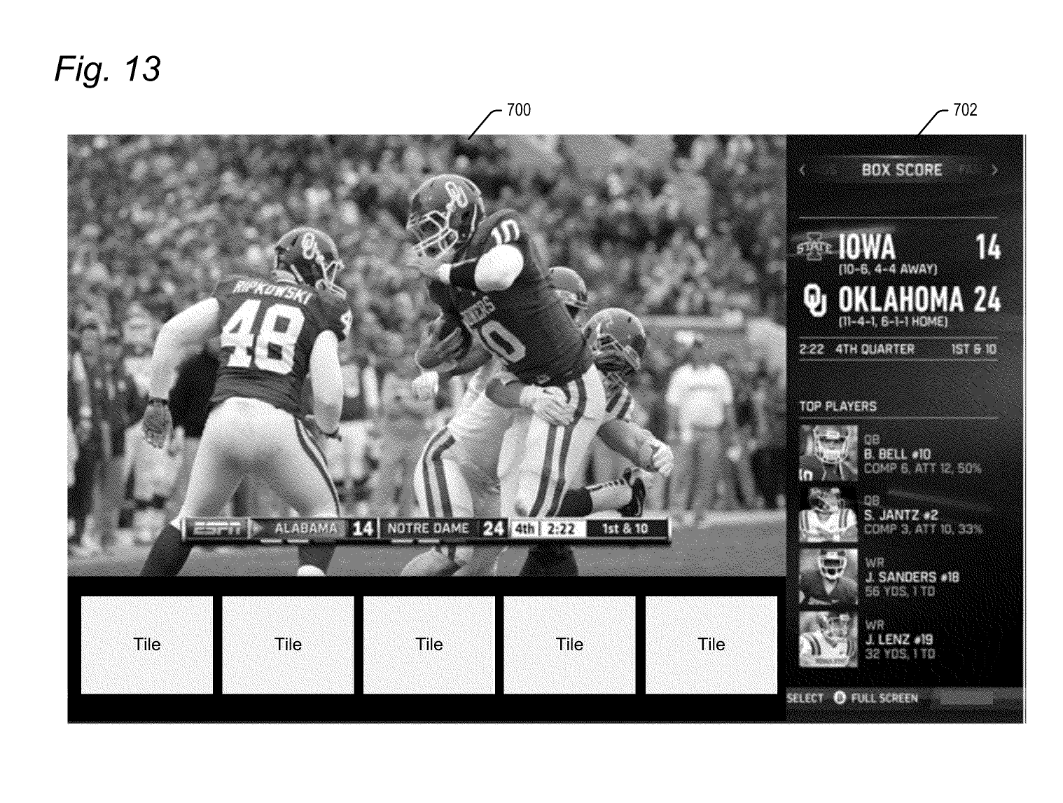

Referring to FIGS. 11, 12 and 13, once cloud data relevant to a video 700 are identified, this information may be displayed alongside the video 700 in an activity panel 702. In particular, FIGS. 11 and 12 provides a general anatomy of a television screen that includes a contextual companion/activity panel. An activity panel 702 may be interactive. In some embodiments, video/image content is transferrable between the activity panel and the rest of the screen. Upon a user selecting the activity panel 702, such as for example via a selection device, the activity panel 702 may present additional information in the activity panel on the selected topic. For example, FIG. 13 depicts that the contextual companion/activity panel shows live boxscore information for the game being played, such that the displayed data is synced through statistics and/or score feeds alongside the video feed.

Moreover, activity panel 702 may include tiles with interactive elements which will correspond to the video stream. These may be curated programmatically and manually by a live operations team. The activity panel 702 may provide a variety of additional links and information, including news stories, and historical, statistical and biographical information. In one example, the central service 122 or other cloud services may use the cloud data to query for relevant related IPTV video content which may then also displayed as part of the expanded activity panel 702.

In an alternative embodiment, selection of a link in the activity panel 702 may bring up additional information that is displayed on a secondary computing device 120, instead of the main display 118 that is displaying the underlying video 700. The SmartGlass® application is a known software platform allowing information to be viewed on a second connected device.

A fourth module is disclosed which determines event significance in a group setting of multiple users/devices and uses this information to route notifications to the most appropriate and relevant device(s)/screen(s). In one example, the notification service 160 determines relevance of content to users. However, in the fourth module, the notification service 160 further determines the relevance of the content to specific members of the group. Initially, the group may register with the central service 122. This may occur automatically, for example as a result of a group of users being co-located at a location 140 and proximate to the computing device 110.

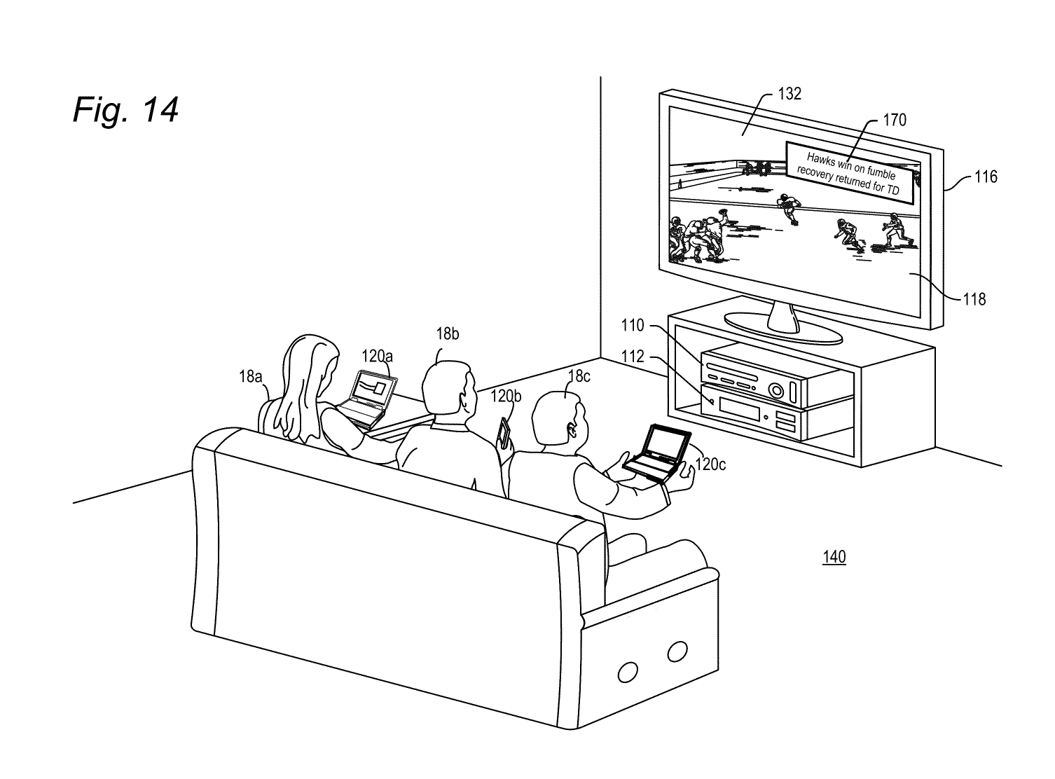

Next, the notification service 160 determines the relevance of content to users in the group, as explained above with respect to the second module. The notification service 160 further determines the number of members to which the content is relevant. Where the content is relevant to all members, or at least some predefined threshold number of members, the notification may be displayed on the main display 118. An example of this is set forth in FIG. 14. The notification service 160 sends the electronic notification to the primary computing device 110. The primary computing device 110 then causes the electronic notification 170 to be displayed to the group as a whole on the main display 118 of A/V device 116. Even though a group notification is displayed on the main display 118, each user in the group may receive a copy of the notification stored on their computing devices 120 so that they may view it at a later time when a user is reviewing a history of notifications received.

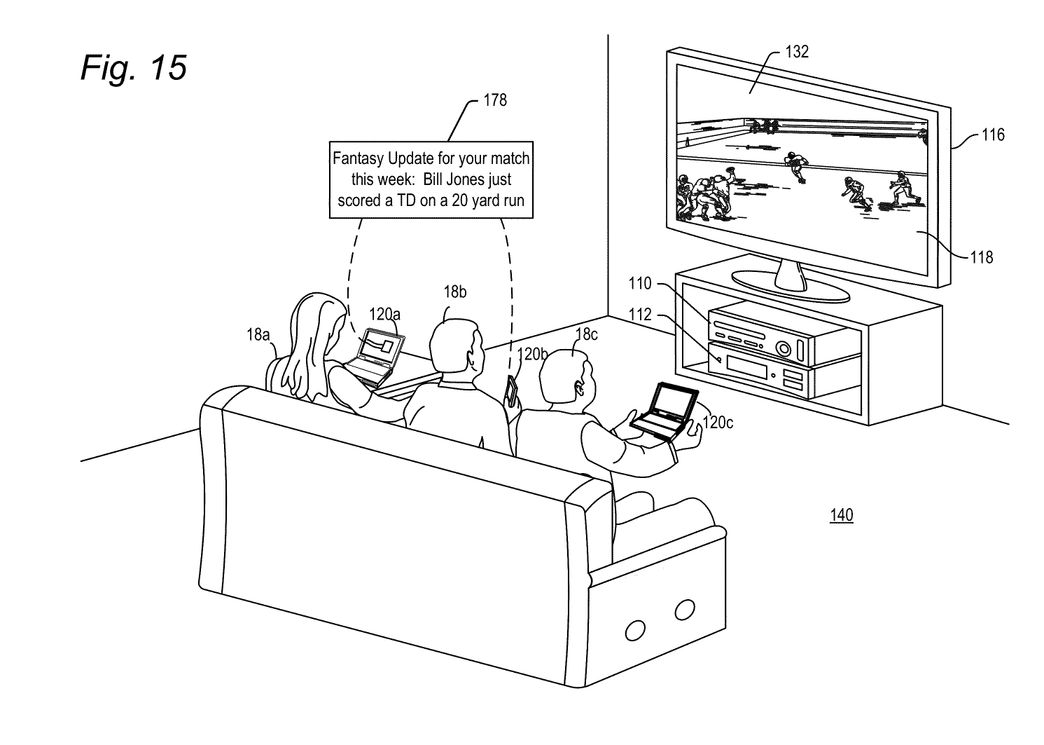

If the notification service 160 determines an electronic notification is a targeted notification for specified users (less than the predefined threshold number of members), the notification service 160 directs that notification to be sent to the secondary computing devices 120 of the specified users. Thus, these targeted users see the notification and other users in the group do not. An example of a targeted notification 178 is illustrated in FIG. 15. In the example of FIG. 15, the notification service 148 may determine that a fantasy update is relevant to users 18a and 18b. In this example, the threshold for a group notification may be 100%. As less than 100% of the group are receiving this update, it is instead sent to both secondary computing devices 120a and 120b for display on those devices.

A fifth module of the present technology is disclosed that allows users to customize main display screen content through interaction with one or more secondary computing devices 120, and have the result display on the main display 118. The seventh module allows a user to select a source of content on a secondary computing device 120 for a given channel that is already displayed on the main display 118. This interaction with a secondary computing device 120 may alter the Content Bar contents associated with the given channel in a Channel Guide on the main display 118. The fifth module may include an algorithm to map secondary computing device screen arrangement of channel user interface components to main display 118 user interface component layout. The fifth module may further include a technique to map and fit secondary computing device screen user interface component additions to an existing main display 118 user interface arrangement.

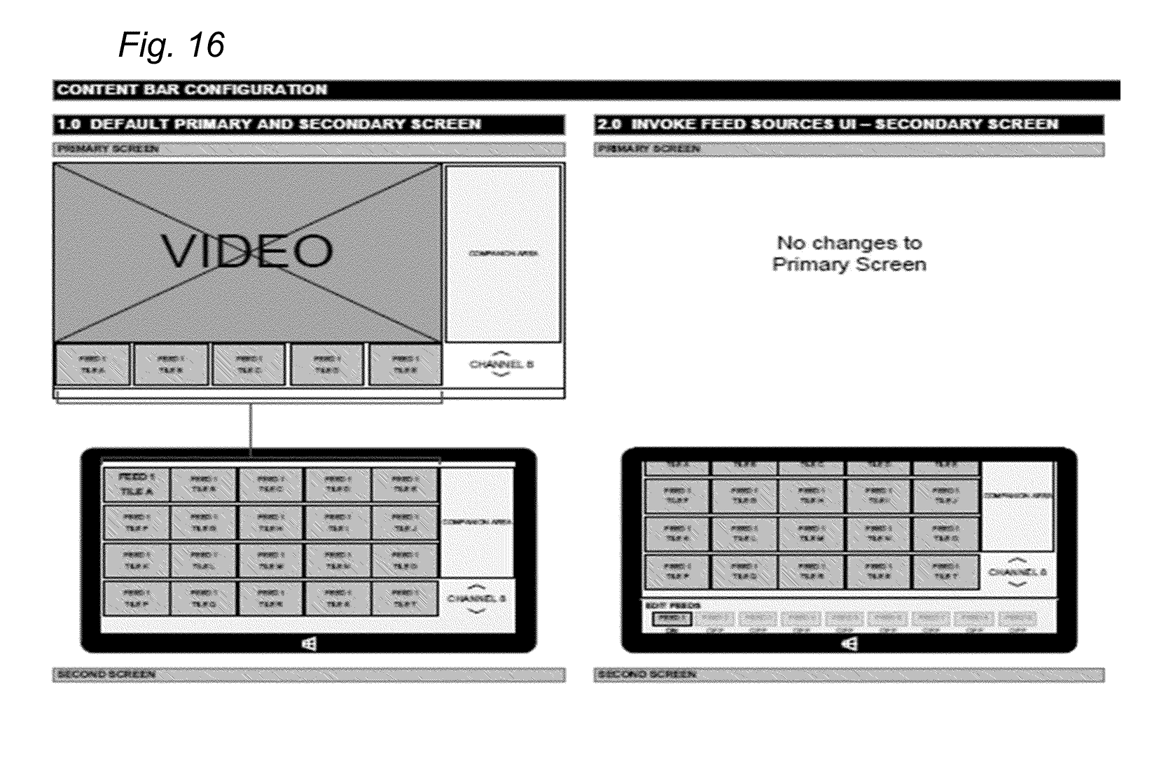

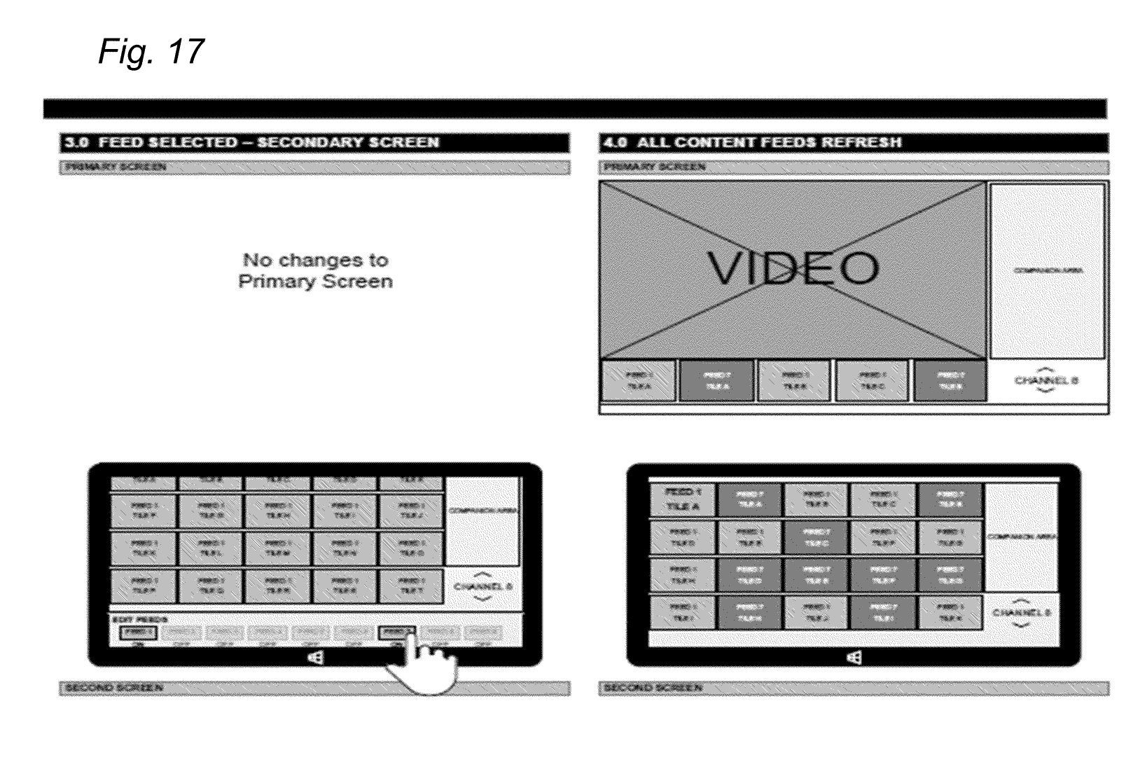

FIGS. 16 and 17 depict an exemplary sequence of interactions with a main display 118 and a screen of a secondary computing device (referred to as a secondary screen). In the scenario during which these sequences occur, a user is viewing content on his or her main display 118 and wants to modify the look or layout of that content. This may include but is not limited to interface element size, shape, color, content, layout, or location. The user may use the secondary screen to perform touch gesture based modifications to the main display 118 content. The second screen may also provide more detail relating to content or data presented by the main display 118 as provided by the central service.

Typically, these gestures would be specific to the platform that is being used for the secondary computing device 120, allowing the user to feel familiar with the process. After the user makes the changes on the secondary device, the changes are applied to the main display 118 dynamically through the use of a background application running on the computing device 110 or central service 122. In some embodiments, the changes to the content on the main display 118 structurally resemble changes to content that the user makes on the secondary screen. In other embodiments, the changes to the content on the main display 118 depend on instructions submitted by the user via the secondary screen, though the changes themselves may not necessarily resemble what occurs on the secondary screen.

FIG. 18 illustrates an example of a NUI system 180 that provides a natural user interface for interacting with the computing device 110. NUI system 180 may include the computing device 110 and A/V device 116 as described above, and may further include a capture device 190, which may be, for example, a camera. Using the capture device 190, the NUI system 180 may be used to recognize, analyze, and/or track one or more humans. For example, a user 18 may be tracked using the capture device 190 such that the gestures and/or movements of user may be captured and interpreted as interactions with the alert notification 160 or the user interface chrome 172. In the example of FIG. 18, the user is interacting with a notification 170, described above, via gestures and/or speech. FIG. 18 also illustrates the present technology in a non-sports related context. In this example, a user is watching a linear broadcast 132 of a monster movie, but as noted, it could any of a wide variety of other linear broadcasts or web content unrelated to sports.

FIG. 19 illustrates an example embodiment of a computing system that may be used to implement computing devices 110, 120 and/or one or more servers of the central service 122. As shown in FIG. 19, the multimedia console 500 has a central processing unit (CPU) 501 having a level 1 cache 502, a level 2 cache 504, and a flash ROM 506 that is non-volatile storage. The level 1 cache 502 and a level 2 cache 504 temporarily store data and hence reduce the number of memory access cycles, thereby improving processing speed and throughput. CPU 501 may be provided having more than one core, and thus, additional level 1 and level 2 caches 502 and 504. The flash ROM 506 may store executable code that is loaded during an initial phase of a boot process when the multimedia console 500 is powered on.

A graphics processing unit (GPU) 508 and a video encoder/video codec (coder/decoder) 514 form a video processing pipeline for high speed and high resolution graphics processing. Data is carried from the graphics processing unit 508 to the video encoder/video codec 514 via a bus. The video processing pipeline outputs data to an A/V (audio/video) port 540 for transmission to a television or other display. A memory controller 510 is connected to the GPU 508 to facilitate processor access to various types of memory 512, such as, but not limited to, a RAM (Random Access Memory).

The multimedia console 500 includes an I/O controller 520, a system management controller 522, an audio processing unit 523, a network (or communication) interface 524, a first USB host controller 526, a second USB controller 528 and a front panel I/O subassembly 530 that are preferably implemented on a module 518. The USB controllers 526 and 528 serve as hosts for peripheral controllers 542(1)-542(2), a wireless adapter 548 (another example of a communication interface), and an external memory device 546 (e.g., flash memory, external CD/DVD ROM drive, removable media, etc. any of which may be non-volatile storage). The network interface 524 and/or wireless adapter 548 provide access to a network (e.g., the Internet, home network, etc.) and may be any of a wide variety of various wired or wireless adapter components including an Ethernet card, a modem, a Bluetooth module, a cable modem, and the like.

System memory 543 is provided to store application data that is loaded during the boot process. A media drive 544 is provided and may comprise a DVD/CD drive, Blu-Ray drive, hard disk drive, or other removable media drive, etc. (any of which may be non-volatile storage). The media drive 544 may be internal or external to the multimedia console 500. Application data may be accessed via the media drive 544 for execution, playback, etc. by the multimedia console 500. The media drive 544 is connected to the I/O controller 520 via a bus, such as a Serial ATA bus or other high speed connection (e.g., IEEE 1394).

The media console 500 may include a variety of computer readable media. Computer readable media can be any available tangible media that can be accessed by console 500 and includes both volatile and nonvolatile media, removable and non-removable media. Computer readable media does not include transitory, transmitted or other modulated data signals that are not contained in a tangible media.

The system management controller 522 provides a variety of service functions related to assuring availability of the multimedia console 500. The audio processing unit 523 and an audio codec 532 form a corresponding audio processing pipeline with high fidelity and stereo processing. Audio data is carried between the audio processing unit 523 and the audio codec 532 via a communication link. The audio processing pipeline outputs data to the A/V port 540 for reproduction by an external audio user or device having audio capabilities.

The front panel I/O subassembly 530 supports the functionality of the power button 550 and the eject button 552, as well as any LEDs (light emitting diodes) or other indicators exposed on the outer surface of the multimedia console 500. A system power supply module 536 provides power to the components of the multimedia console 500. A fan 538 cools the circuitry within the multimedia console 500.

The CPU 501, GPU 508, memory controller 510, and various other components within the multimedia console 500 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 500 is powered on, application data may be loaded from the system memory 543 into memory 512 and/or caches 502, 504 and executed on the CPU 501. The application may present a graphical user interface that provides a consistent user experience when navigating to different media types available on the multimedia console 500. In operation, applications and/or other media contained within the media drive 544 may be launched or played from the media drive 544 to provide additional functionalities to the multimedia console 500.

The multimedia console 500 may be operated as a standalone system by simply connecting the system to a television or other display. In this standalone mode, the multimedia console 500 allows one or more users to interact with the system, watch movies, or listen to music. However, with the integration of broadband connectivity made available through the network interface 524 or the wireless adapter 548, the multimedia console 500 may further be operated as a participant in a larger network community. Additionally, multimedia console 500 can communicate with processing unit 4 via wireless adaptor 548.

When the multimedia console 500 is powered ON, a set amount of hardware resources are reserved for system use by the multimedia console operating system. These resources may include a reservation of memory, CPU and GPU cycle, networking bandwidth, etc. Because these resources are reserved at system boot time, the reserved resources do not exist from the application's view. In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., pop-ups) are displayed by using a GPU interrupt to schedule code to render popup into an overlay. The amount of memory for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resync is eliminated.

After multimedia console 500 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 501 at predetermined times and intervals in order to provide a consistent system resource view to the application. The scheduling is to minimize cache disruption for the gaming application running on the console.

When a concurrent system application uses audio, audio processing is scheduled asynchronously to the gaming application due to time sensitivity. A multimedia console application manager (described below) controls the gaming application audio level (e.g., mute, attenuate) when system applications are active.

Optional input devices (e.g., controllers 542(1) and 542(2)) are shared by gaming applications and system applications. The input devices are not reserved resources, but are to be switched between system applications and the gaming application such that each will have a focus of the device. The application manager preferably controls the switching of input stream, without knowing the gaming application's knowledge and a driver maintains state information regarding focus switches. Capture device 190 may define additional input devices for the console 500 via USB controller 526 or other interface. In other embodiments, computing devices 110, 120 can be implemented using other hardware architectures. No one hardware architecture is required.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A method for presenting content via a display screen associated with a computing device, comprising:
(a) aggregating, in a central service, cloud data from a plurality of sources remote from the central service;
(b) identifying, in the central service, content from cloud data aggregated in said step (a) that is potentially of interest to a user of the computing device; and
(c) forwarding, automatically and/or in response to a user request, the content identified in said step (b) for display on the display associated with the computing device.

2. The method recited in claim 1, wherein said step (a) of aggregating cloud data from a plurality of sources comprises the step of aggregating cloud data from two or more content provider services.

3. The method recited in claim 1, wherein said step (b) of identifying content that is potentially of interest to the user comprises the step of comparing user preferences stored in the central service for the user against data associated with the content to identify a correlation between the stored user preferences and the data.

4. The method recited in claim 3, wherein said step of comparing user preferences against data associated with the content comprises the step of comparing user preferences against metadata associated with the content.

5. The method recited in claim 1, wherein said step (b) of identifying content that is potentially of interest to the user comprises the step of identifying an underlying video being displayed on the display and finding content that is related to the underlying video.

6. The method recited in claim 1, further comprising the step of configuring, in the central service, an interactive user interface for display on the display associated with the computing device, the content forwarded in said step (c) displayed in the user interface.

7. The method recited in claim 6, wherein said step of configuring an interactive user interface comprises the step of configuring layout and relative sizes of a window and one or more tiles, and configuring whether the one or more tiles display video, graphics or text.

8. The method recited in claim 6, wherein said step of configuring an interactive user interface comprises the step of configuring a plurality of channels, the content forwarded in said step (c) divided by category among the plurality of channels.

9. The method recited in claim 6, wherein said step of configuring an interactive user interface comprises the step of configuring an activity panel for display alongside an underlying video, the activity panel displaying content that is related to the underlying video.

10. The method recited in claim 6, wherein said step of configuring an interactive user interface comprises the step of configuring a notification for display on top of an underlying video displayed on the display, the notification containing a message relating to the content identified in said step (b).

11. A system for presenting content via a display screen associated with a computing device, the system comprising:
an aggregation service for aggregating cloud data from one or more third-party content providers;
a user preference service for receiving user preferences from a user of the computing device;
a content determination service for examining the cloud data and user preferences and identifying content to forward to the computing device based on at least one of a user request and an identified relation between the cloud data and the user preferences; and
a programming tool including a set of rules for formatting a user interface for the presentation of the content identified by the content determination service.

12. The system of claim 11, wherein the aggregation service comprises a sports fantasy aggregator service for aggregating cloud data relating to one or more sports fantasy leagues.

13. The system of claim 11, wherein the content determination service comprises a notification service for generating notifications to forward to the computing device.

14. The system of claim 11, wherein the content determination service further receives data relating to an underlying video being displayed on the display associated with the computing device, the content determination service further determining content to forward to the computing device based on an identified relation between the cloud data and the underlying video.

15. The system of claim 11, the computing device comprising a primary computing device and the display comprising a main display, the system further comprising a group of one or more secondary computing devices, having secondary displays, co-located with the primary computing devices, the secondary computing devices communicating with the primary computing devices and displaying content relevant to an underlying video on the main display.

16. The system of claim 15, the content displayed on the group of secondary computing devices being the content identified by the content determination service.

17. A computer-readable medium for programming a processor to perform a method of presenting content via a display screen associated with a computing device, comprising:
(a) aggregating cloud data from a plurality of sources remote from the central service;
(b) receiving user preferences for a group of one or more users;
(c) identifying content from cloud data aggregated in said step (a) that is potentially of interest to a user of the computing device;
(d) defining a group of two or more channels, the content identified in said step (c) divided by content subject matter into the two or more channels;
(e) setting a layout of a user interface for displaying the group of two or more channels and content identified in said step (c); and
(f) forwarding the content identified in said step (c), automatically and/or in response to a user request, the channels defined in said step (d) and the layout set in said step (e) for displaying the content on the display associated with the computing device.

18. The computer-readable medium of claim 17, wherein said step (b) of receiving user preferences comprises the step of receiving user preferences on selection of channels and the division of content into the channels, the definition of channels in said step (d) based in part on the user preferences received relating to the selection of channels and the division of content into the channels.

19. The computer-readable medium of claim 17, wherein said step (b) of receiving user preferences comprises the step of receiving user preferences on the layout of the user interface, the setting of the layout of the user interface in said step (e) based in part on the user preferences received relating to the layout of the user interface.

20. The computer-readable medium of claim 17, the display device comprising a main display device, the method further comprising the step of forwarding the content identified in said step (c) for display on a group of one or more secondary display devices co-located with the main display device and in communication with the computing device associated with the main display device.
